(19) United States
(12) Patent Application Publication
(10) Pub. No.: US 2013/0326358 A1
(43) Pub. Date: Dec. 5, 2013

(54) SYSTEM AND METHOD FO PROVIDING AN APPLICATION LOCK

(71) Applicant: Andrew Scarborough, North Bondi (AU)

(72) Inventor: Andrew Scarborough, North Bondi (AU)

(73) Assignee: Lockerteck PTY LTD, New South Wales (AU)

(21) Appl. No.: 13/988,735

(22) PCT Filed: Nov. 18, 2011
(86) PCT No.: PCT/AU11/01493

§ 371 Date: Aug. 5, 2013

(30) Foreign Application Priority Data
Nov. 22, 2010 (AU) 2010905149

(51) Int. Cl. H04L 12/911

(52) U.S. Cl. CPC H04L 47/70
USPC 715/741

(57) ABSTRACT

A portable electronic device including: a memory for storing information relating to an application; a display for displaying at least a portion of the information stored on the memory; and a user interface for allowing the user to activate the application; a network interface for connecting the device to a network and for allowing the application to access a database connected to the network, the database storing application access information such that when the user activates the application, access to the application is locked or unlocked according to the access information.

### FIELD OF THE INVENTION

The present invention relates to portable electronic devices and in particular to systems and methods for providing application locks on portable electronic devices and will be described with reference to this application. However, it will be appreciated that the invention is not limited to this particular field of use.

### BACKGROUND OF THE INVENTION

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Portable electronic devices have increased in popularity and many people now carry at least one portable electronic device with them throughout the day. The device may take the form of a portable computer, a mobile phone, a smart phone, a personal digital assistant, personal music player or the like. User difficulties in accessing and transporting multiple devices has led to the introduction of newer smart devices that can run multiple applications on a single device thereby avoiding the need for a user to carry multiple devices around with them. Instead the user simply activates the desired function on the smart device and can switch to another application as required. Many devices also provide the user with the ability to download and install new applications onto the smart device.

In light of the above, there is great demand for new applications, however, there is reluctance from some users to pay for each application they wish to use. Some users are also reluctant to purchase applications until they have had a chance to use the desired application. While software developers may offer free time based trials of particular applications there is a need to provide alternatives to this.

### SUMMARY OF THE INVENTION

The preferred embodiment of the present invention overcomes or ameliorates at least one of the disadvantages of the prior art, or at least provides a useful alternative.

According to a first aspect of the invention there is provided a portable electronic device including:
a memory for storing information relating to an application;
a display for displaying at least a portion of the information stored on the memory; and
a user interface for allowing the user to activate the application;
a network interface for connecting the device to a network and for allowing the application to access a database connected to the network, the database storing application access information
such that when the user activates the application, access to the application is locked or unlocked according to the access information.

Preferably access to the application is locked until the user completes a predetermined activity.

Preferably the predetermined activity is performed though a web browser stored on the device.

In other embodiments the activities can be accessed through a widget, app, or other network enables software application. In some embodiments the activities are accessed through a locking application.

Preferably the web browser is automatically activated upon activation of the application.

Preferably the database is updated upon completion of the predetermined activity thereby unlocking the application.

Preferably the user is provided the option of completing one of a number of predetermined activities.

Preferably the user controls the user interface to select the one of the number or predetermined activities. Preferably the web browser actuates upon the user selecting one of the predetermined activities.

Preferably the predetermined activities are completed using the web browser.

Preferably the activation database stores unique information relating to the portable electronic device.

Preferably the activation database stores unique information relating to the user.

Preferably the predetermined activities include one or more of the following: signing up for a promotional deal; a purchase; a referral,

Preferably the network interface is a wireless network. More preferably the network interface is a mobile phone wireless network.

Preferably the network is connected to the Internet.

Preferably the database is connected to the Internet and communicates with the device through the Internet and the mobile phone network.

Preferably the device checks the access information upon the user activating the application.

Preferably if access to the application is locked, the device displays the activation activities on the display for selection by the user.

Preferably the web browser is activated upon selection of one of the activation activities by the user.

Preferably the state of the application is saved when the browser is activated.

Preferably the activation activity includes a plurality of steps.

Preferably upon completion of a final step of the activation activity, the application access information is updated thereby unlocking the application.

Preferably the application is reactivated upon completion of the final step of the activation activity.

Preferably the predetermined activation activities are stored in an activity database.

Preferably the activity database is connected to the Internet and is in communication with the device and the activation database.

Preferably the final step of the activation activity includes the actuation of a predetermined unlocking code or software thereby unlocking the application.

In other embodiments the final step of the activation activity includes the firing of a pixel thereby unlocking the application.

Preferably the pixel is fired upon the completion of a predetermined step of the activation activity.

Preferably the firing of the pixel includes the running of a specific piece of code or software.

Preferably the access information is stored in the activation database according to the unique information relating to the portable electronic device and/or the unique information relating to the user.

Preferably the access information stores information relating to a plurality of applications.

Preferably the access information is updated by a provider of the application access information database.

According to a second aspect of the invention there is provided a method of locking an application including the steps of:
providing a portable electronic device having a memory for storing information relating to the application;
providing a display for displaying at least a portion of the information stored on the memory;
providing a user interface for allowing the user to activate the application; and providing a network interface for connecting the device to a network and for allowing the application to access a database connected to the network, the database storing application access information such that when the user activates the application, access to the application is locked or unlocked according to the access information.

Preferably the method includes locking access to the application until the user completes a predetermined activity.

Preferably the method includes the step of performing the predetermined activity though a web browser stored on the device.

Preferably the method includes the step of the web browser being automatically activated upon activation of the application.

Preferably the method includes the step of the database being updated upon completion of the predetermined activity thereby unlocking the application.

Preferably the method includes the step of the user being provided the option of completing one of a number of predetermined activities.

Preferably the method includes the step of the user controlling the user interface to select the one of the number or predetermined activities. Preferably the method includes the step of the web browser actuating upon the user selecting one of the predetermined activities.

Preferably the method includes the step of completing the predetermined activities using the web browser.

Preferably the method includes the step of the activation database storing unique information relating to the portable electronic device.

Preferably the method includes the step of the activation database storing unique information relating to the user.

Preferably the predetermined activities include one or more of the following: signing up for a promotional deal; a purchase; a referral,

Preferably the network interface is a wireless network. More preferably the network interface is a mobile phone wireless network.

Preferably the method includes the step of connecting the network to the Internet.

Preferably the method includes the step of connecting the database to the Internet and allowing the database to communicate with the device through the Internet and the mobile phone network.

Preferably the method includes the step of the device checking the access information upon the user activating the application.

Preferably if access to the application is locked, the method includes the step of the device displaying the activation activities on the display for selection by the user.

Preferably the method includes the step of activating the web browser upon selection of one of the activation activities by the user.

Preferably the method includes the step of saving the state of the application when the browser is activated.

Preferably the activation activity includes a plurality of steps.

Preferably upon completion of a final step of the activation activity, the application access information is updated thereby unlocking the application.

Preferably the method includes the step of reactivating the application upon completion of the final step of the activation activity.

Preferably the method includes the step of storing the predetermined activation activities in an activity database.

Preferably the method includes the step of connecting activity database to the Internet and communicating with the device and the activation database.

Preferably the final step of the activation activity includes the actuation of a predetermined unlocking code or software thereby unlocking the application.

In other embodiments the final step of the activation activity includes the firing of a pixel thereby unlocking the application.

Preferably the pixel is fired upon the completion of a predetermined step of the activation activity.

Preferably the firing of the pixel includes the running of a specific piece of code or software.

Preferably the unlocking of the application includes the step of firing a pixel to unlock the application.

Preferably the method includes the step of storing access information in the activation database according to the unique information relating to the portable electronic device and/or the unique information relating to the user.

Preferably the access information stores information relating to a plurality of applications.

Preferably the method includes the step of a provider of the application access information database updating the access information.

Throughout the specification and claims which follow, unless the context requires otherwise, the word “comprise”, and other variations such as “comprises” and “comprising”, will be understood to imply the inclusion of a stated integer or step or group of integers or steps but not the exclusion of any other integer or step or group of integers of steps.

### BRIEF DESCRIPTION OF THE DRAWINGS

A preferred embodiment of the invention will now be described, by way of example only, with reference to the accompanying drawings in which:

FIG. 1 is a flow diagram of according to the invention shown in the form of an Iphone Application Unlocker;

FIG. 2 is a alternative flow diagram of according to the invention shown in the form of an Iphone Application Unlocker; and

FIG. 3 is a diagram of a device running an application according to the invention.

### PREFERRED EMBODIMENT OF THE INVENTION

The preferred embodiment of the invention provides a portable electronic device in the form of an Iphone. It would be understood though that the invention can be implemented on any suitable device such as an Ipad, Blackberry, Android device and the like. The device includes a memory for storing information relating to an application and has a display for displaying at least a portion of the information stored on the memory. The device has a user interface for allowing the user to activate the application and a network interface for connecting the device to a network and for allowing the application to access a database connected to the network. The database stores application access information such that when the user activates the application, access to the application is locked or unlocked according to the access information.

The invention provides means to lock an application running on a suitable device until the user has completed the necessary steps to unlock the application. That is, the user cannot use the application or can only use a limited portion of the application until they complete the require activation steps. The application may be an application that is preloaded onto the device or may be an application that has been installed onto the device by the user. The activation steps in the preferred embodiment consists of the user selection from one or more offers and completing the offers to unlock the application and gain access to the application.

In the preferred embodiment access to the application is locked until the user completes a predetermined activity. In some embodiments though it may be advantageous to provide a trial period during which the application is unlocked so that users can use the application prior to completing one of the offers. The trial may be time based (i.e. 1 day, 1 week and the like) or use based (i.e. the user may use the application 5 times before it is locked).

Upon loading a locked application the user must complete a predetermined unlocking activity to unlock the application. The unlocking activity is performed though a web browser stored on the device however in some embodiments the unlocking activity is performed through another application, widgets, software application or the like. Typically the web browser on the device is automatically activated upon activation of the application however in some embodiments the user must click an offer button which will then activate the web browser and take the user to the offer web page.

In some embodiments the unlocking activity is performed through an unlocking procedure of sub application running within the main application. In this way there is no need to load an additional application or web browser.

Upon completing the activation offer, the activation database is updated thereby unlocking the application.

In some embodiments the user is provided the option of completing one of a number of predetermined unlocking activities and can choose the activity they wish to complete. As an example only the activities could be signing up for a free offer such as a home delivery movie service, a free trial of a product, a discounted purchase and the like.

Typically the offers are designed to obtain contact details such as email, phone number and the like of clients to provide them with offers that relate to their chosen offer. The predetermined activities should generally include one or more of the following: signing up for a promotional deal; a purchase; a referral,

To choose one of the offers, the user controls the user interface with the Iphone touch screen to select the one of the number or predetermined activities. When the user selects the chosen activity, the web browser actuates taking the use to the offer website where the predetermined activities can be completed.

The activation database stores unique information relating to the portable electronic device and/or unique information relating to the user. In that way the activation database can store lock and unlock information for a plurality of users whereby the application is locked for one user but unlocked for another user. In the case of an Iphone the unique device information is the UID. In other embodiments the unique information could be an email address, MAC address or any other suitable unique identifier.

In the preferred embodiment the network interface used by the device is a wireless network. The wireless network is typically a mobile phone wireless network but could be any suitable wireless network such as WIFI, Bluetooth and the like. In the preferred embodiment the mobile phone network is connected to the Internet thereby allowing traffic between the device and the Internet. As such, the database is connected to the Internet and communicates with the device through the Internet and the mobile phone network. When the application is activated or loaded by the user, the device requests the access information from the access database. If the application is locked then the device displays the activation activities on the display for selection by the user. Once the user selects the chosen activity the web browser is activated and directed to the website link of the activity.

In some cases where multitasking is not available, it may be necessary to maintain the state of the application. If this is the case the application saves its state when the browser is activated.

In the preferred embodiment the activation activity includes a plurality of steps for the user to complete in order to successfully unlock the application. Upon completion of a final step of the activation activity, the application access information is updated thereby unlocking the application. Upon completion of the final step of the activation activity the application is reactivated, unlocked and ready to be used. Upon successful completion, the final step of the activation activity the unlocking of the applications includes the running or actuation of specific pieces of code or software thereby unlocking the application. In some embodiments this may includes the firing of a pixel thereby unlocking the application.

As would be understood, the predetermined activation activities are stored in an activity database which is connected to the Internet. The activity database is also in communication with the device and the activation database.

In the preferred embodiment the access information is stored in the activation database according to the unique information relating to the portable electronic device and/or the unique information relating to the user. This allows the unique status of a plurality of users' to be maintained and also allows the database to store information relating to a plurality of applications.

If necessary, the locked or unlocked access information can be updated by a provider of the application access information database. This may be required when an application is updated, when the current unlocked status of the application expires, if the application developer wishes to realign the application or for any other reason deemed necessary.

In order to allow the application to be locked or unlocked, a Software Development Kit (SDK) is inserted into the application when it is developed. The SDK turns the lock on or off in the application.

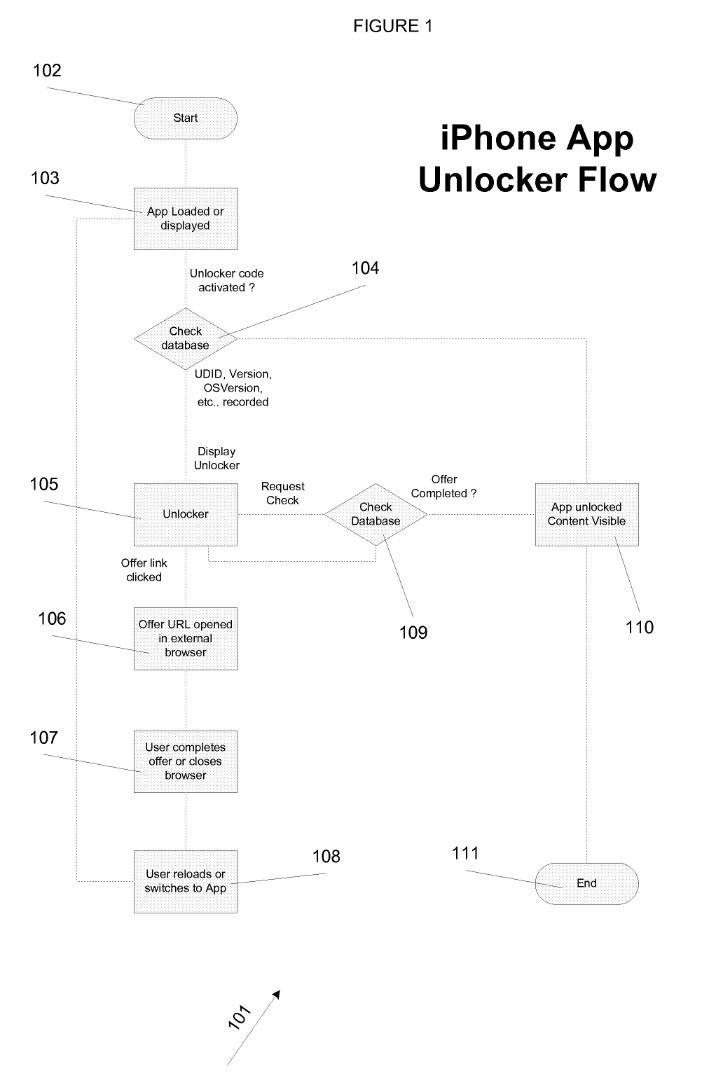

Referring to FIG. 1 there is shown a flow diagram 101 for an Iphone App Unlocker. The process starts at 102 when the user turns on the device. At 103 the user loads the desired application. At 104 the device queries the access database to determine whether the application should be locked for the user and device. If the application is locked the process continues at 105 where the user is provided with a plurality of offers, one of which must be taken to unlock the application. The user selects the desired offer and the process continues to 106 where the device browser is opened. The user then completes or closes the browser at 107. Also at this step if the offer is successfully completed the access information database will be updated.

At 108 the user reloads the application or switches back to the application and the process returns to 103. At 104 if the offer was successfully completed the access database will show that the application is unlocked for the user and/or device and the application is unlocked and available at 110. The process ends with the user using the application 111.

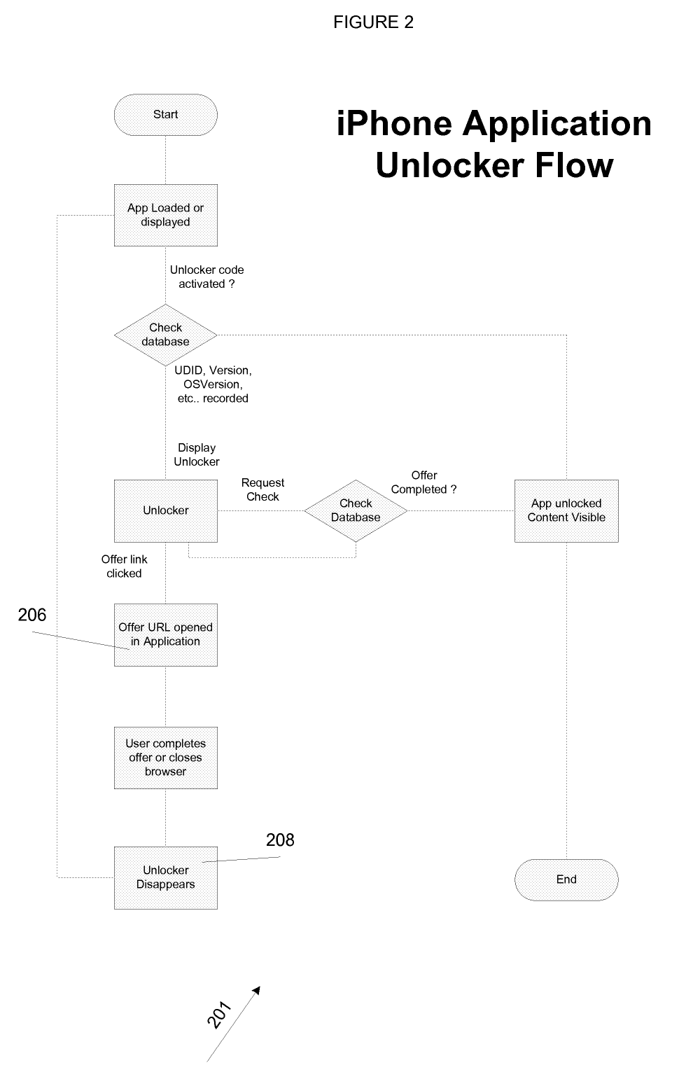

FIG. 2 shows a flow diagram of another embodiment of the invention where the offer URL is shown within the application at step 206 and not in a browser window. This embodiment can be advantageous as there is no need to save the state of the application when switching to a browser or a need to multitask. In this embodiment, the unlocker disappears at step 208 rather than the device switching back to the application.

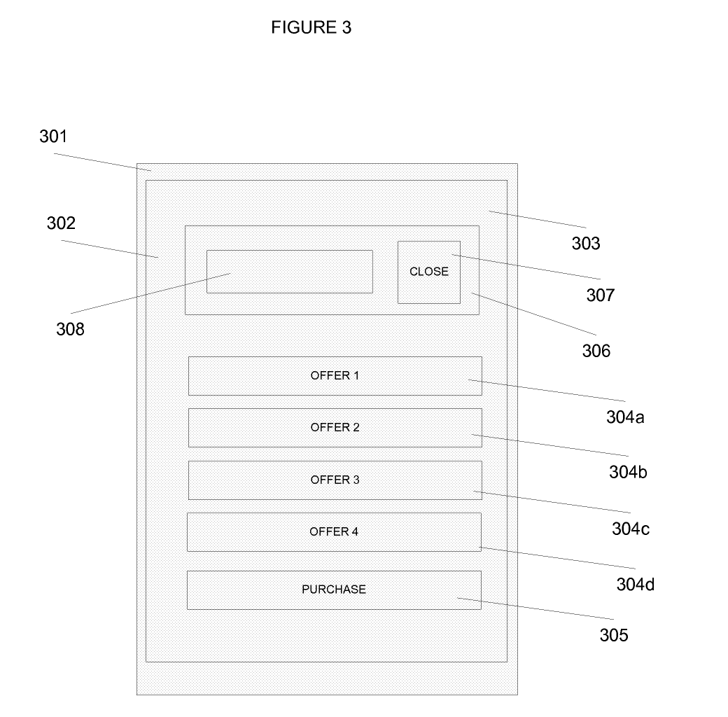

Referring to FIG. 3 there is shown a device such as an Iphone 301 running an application 303 displayed on screen 302. The application is shown in the locked status and the advert display is overlayed over the application blocking out the application screen such that the user can only see the offer details and not the application. The user is able to select one of the offers 304a, 304b, 304c or 304d. The offers can be shown in any suitable form such as text, graphic, movie or the like. Optionally a purchase option 305 can also be shown whereby the user can choose to pay a fee to remove the lock rather than complete one of the offers.

The application also includes a control bar 306 which can include control buttons and control information. In this embodiment the a close button 307 is included but it would be understood that a plurality of buttons may be included as required. A control message display 308 is also included to optionally display control information flowing from and/or to the device from and to the server.

Any commercial processor may be used to implement the embodiments of the invention either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD, Intel Centrino™ Intel Core Duo™, Intel Core 2 Duo™, Intel Centrino™, Intel Xeon™ and the like.

Display screens may be segment display screen, analogue display screens, digital display screens, CRTs, LED screens, Plasma screens, liquid crystal diode screens, and the like.

Although the invention has been described with reference to specific examples, it will be appreciated by those skilled in the art that the invention may be embodied in many other forms.

1. A portable electronic device comprising:
a memory for storing information relating to an application;
a display for displaying at least a portion of the information stored on the memory; and
a user interface for allowing the user to activate the application;
a network interface for connecting the device to a network and for allowing the application to access a database connected to the network, the database storing application access information such that when the user activates the application, access to the application is locked or unlocked according to the access information.

2. An electronic device according to claim 1 wherein the application is locked until the user completes a predetermined activity.

3. An electronic device according to claim 2 wherein the predetermined activity is performed though a web browser stored on the device.

4. (canceled)

5. An electronic device according to claim 3 wherein the web browser is automatically activated upon activation of the application.

6. An electronic device according to claim 2 wherein the database is updated upon completion of the predetermined activity thereby unlocking the application.

7. An electronic device according to claim 6 wherein the user is provided the option of completing one of a number of predetermined activities.

8. An electronic device according to claim 7 wherein the user controls the user interface to select the one of the number or predetermined activities.

9. An electronic device according to claim 8 wherein the web browser actuates upon the user selecting one of the predetermined activities.

10. An electronic device according to claim 9 wherein the predetermined activities are completed using the web browser.

11. An electronic device according to claim 10 wherein the activation database stores unique information relating to the portable electronic device.

12. An electronic device according to claim 11 wherein the activation database stores unique information relating to the user.

13-18. (canceled)

19. An electronic device according to claim 12 wherein the activation activity includes a plurality of steps.

20. An electronic device according to claim 19 wherein upon completion of a final step of the activation activity, the application access information is updated thereby unlocking the application.

21. (canceled)

22. An electronic device according to claim 20 wherein the predetermined activation activities are stored in an activity database.

23. (canceled)

24. An electronic device according to claim 22 wherein the final step of the activation activity includes the actuation of a predetermined unlocking code or software thereby unlocking the application.

25. An electronic device according to claim 23 wherein the final step of the activation activity includes the firing of a pixel thereby unlocking the application.

26. An electronic device according to claim 25 wherein the pixel is fired upon the completion of a predetermined step of the activation activity.

27. An electronic device according to claim 26 wherein the firing of the pixel includes the running of a specific piece of code or software.

28. An electronic device according to claim 27 wherein the access information is stored in the activation database according to the unique information relating to the portable electronic device and/or the unique information relating to the user.

29. (canceled)

30. A method of locking an application comprising including the steps of:
providing a portable electronic device having a memory for storing information relating to the application;
providing a display for displaying at least a portion of the information stored on the memory;
providing a user interface for allowing the user to activate the application; and
providing a network interface for connecting the device to a network and for allowing the application to access a database connected to the network, the database storing application access information such that when the user activates the application, access to the application is locked or unlocked according to the access information.
